(19) United States
(12) Patent Application Publication
(10) Pub. No.: US 2023/0292937 A1
(43) Pub. Date: Sep. 21, 2023

(54) HIDDEN PULL-OUT BRACKET

(71) Applicant: Shenzhen Yisidao Technology Co., Ltd., Shenzhen (CN)

(72) Inventors: Feng LI, Shenzhen (CN); Yuhua HU, Shenzhen (CN)

(21) Appl. No.: 17/837,146

(22) Filed: Jun. 10, 2022

(30) Foreign Application Priority Data
Mar. 19, 2022 (CN) 202220510419.1

(51) Int. Cl. A47G 1/02; F16M 11/06

(52) U.S. Cl. CPC A47G 1/02; F16M 11/06

(57) ABSTRACT

Provided is a hidden pull-out bracket, comprising a base and a supporting piece. The base comprises a recess, a first connecting piece and a second connecting piece. The recess is arranged on the base, a lower end of the first connecting piece is connected to an interior of the recess, and an upper end of the first connecting piece protrudes from the recess. The second connecting piece is connected to the upper end of the first connecting piece, and two sides of the second connecting piece are connected with limiting pieces. One end of the supporting piece is provided with a storage bucket, and an inner side of a side wall of the storage bucket is slidably connected to the second connecting piece. The other end of the supporting piece is connected with a fixing piece, and the fixing piece is used for fixing a mirror.

### CROSS REFERENCE TO RELATED APPLICATIONS

This application claims foreign priority of Chinese Patent Application No. 202220510419.1, filed on Mar. 19, 2022 in the China National Intellectual Property Administration, the disclosures of all of which are hereby incorporated by reference.

### TECHNICAL FIELD

The utility model relates to the field of daily necessities, and more particularly, to a bracket.

### BACKGROUND

In modern society, a user fixes a mirror through a bracket, so that the user can conveniently place the mirror on a desktop. Since the existing bracket is difficult to be stored, the bracket needs to occupy a larger storage space. Therefore, there is a technical problem that it is inconvenient for the user to carry the existing bracket.

Therefore, it is necessary to provide a hidden pull-out bracket to solve the technical problem above.

### SUMMARY

The utility model provides a hidden pull-out bracket, which effectively solves the technical problem that the user is inconvenient to carry the existing bracket.

The utility model provides a hidden pull-out bracket, comprising:
a base, comprising:
   a recess arranged on the base;
   a first connecting piece, a lower end of the first connecting piece being connected to an interior of the recess, and an upper end of the first connecting piece protruding from the recess;
   a second connecting piece connected to the upper end of the first connecting piece, two sides of the second connecting piece being connected with limiting pieces; and
   a supporting piece, one end of the supporting piece being provided with a storage bucket, an inner side of a side wall of the storage bucket being slidably connected to the second connecting piece, the storage bucket being used for storing the first connecting piece and the second connecting piece, the other end of the supporting piece being connected with a fixing piece, and the fixing piece being used for fixing a mirror;
   wherein, when the supporting piece is located at a first operating position, the storage bucket is sleeved outside the first connecting piece and the second connecting piece, one end of the storage bucket is located in the interior of the recess, and the recess limits the supporting piece to the first operating position; and when the supporting piece is located at a second operating position, the storage bucket is sleeved on an upper end of the second connecting piece, the limiting piece limits the supporting piece to the second operating position, and the supporting piece is rotationally connected to the first connecting piece through the second connecting piece, and used for folding the supporting piece for a user to support the mirror on the fixing piece of the hidden pull-out bracket. The hidden pull-out bracket can preferably support the mirror. When the supporting piece is located at the first operating position, both the first connecting piece and the second connecting piece are hidden inside the supporting piece. Therefore, when the user uses the hidden pull-out bracket, the hidden pull-out bracket can save a part of space needed thereof. After the user pulls out the supporting piece from the first operating position to the second operating position, the supporting piece can rotate through the second connecting piece and the first connecting piece, so that the user can fold the supporting piece. After the user folds the supporting piece, the user can conveniently carry the mirror.

Further, the inner side of the side wall of the storage bucket is provided with a limiting slot, the limiting slot is slidably connected to the limiting piece, the limiting slot is used for limiting the limiting piece, one end of the limiting slot is provided with a first clamping position, the other end of the limiting slot is provided with a second clamping position, when the supporting piece is located at the first operating position, the limiting piece is connected to the first clamping position, and when the supporting piece is located at the second operating position, the limiting piece is clamped and fixed with the second clamping position.

Further, the first connecting piece is provided with a first through hole, the first connecting piece further comprises a rotating shaft, the rotating shaft is connected in the first through hole, a lower end of the second connecting piece is provided with a second through hole, the rotating shaft penetrates through the second through hole, and the second connecting piece is rotationally connected to the first connecting piece through the rotating shaft.

Further, when the supporting piece rotates through the second connecting piece and the first connecting piece, the supporting piece is located at a third operating position, and the supporting piece is parallel to the base for better accommodating the hidden pull-out bracket.

Further, the first connecting piece is integrally formed with the base, so that connection between the first connecting piece and the base is more stable.

Further, the second connecting piece comprises a bump, the bump is connected to the lower end of the second connecting piece, the second through hole is located in the bump, a lower end of the bump is semicircular, and the upper end of the first connecting piece is arc-shaped for the second connecting piece to rotate conveniently.

Further, the upper end of the first connecting piece is connected with a first limiting block, the lower end of the second connecting piece is connected with a second limiting block, the second limiting block is located between the two bumps, and when the second connecting piece rotates on the first connecting piece, the second limiting block is used for matching with the first limiting block to limit the second connecting piece.

Further, the supporting piece comprises a reinforcing rib, and the reinforcing rib is connected to an interior of the supporting piece for increasing a strength of the supporting piece.

Further, two fixing pieces are respectively connected with a clamping block, the two clamping blocks are oppositely arranged, and the clamping blocks are used for matching with clamping slots or through holes in the mirror to fix the mirror.

Further, the base further comprises a plurality of anti-skidding pieces, the anti-skidding pieces are connected to a lower end of the base, and the anti-skidding pieces are used for preventing the base from skidding.

Compared with the prior art, the utility model has the following beneficial effects. The utility model provides a hidden pull-out bracket, on which a mirror is installed. The bracket comprises a supporting piece and a base, and one end of the supporting piece is provided with a storage bucket. When the supporting piece is located at a first operating position, the storage bucket is sleeved outside a first connecting piece and a second connecting piece. Moreover, one end of the storage bucket is located in a recess of the base. Therefore, both the first connecting piece and the second connecting piece are hidden in the storage bucket, such that a height of the hidden pull-out bracket is reduced. Therefore, when a user uses the hidden pull-out bracket, the hidden pull-out bracket can save a part of space needed thereof. Moreover, after the user pulls out the supporting piece from the first operating position to the second operating position, the supporting piece can rotate through the second connecting piece and the first connecting piece, so that the user can fold the supporting piece. After the user folds the supporting piece, the user can conveniently carry the bracket. The technical problem that it is inconvenient for the user to carry the existing bracket is effectively solved.

### BRIEF DESCRIPTION OF THE DRAWINGS

In order to illustrate the technical solutions in the embodiments of the utility model or in the related art more clearly, the drawings that are required to describe the embodiments will be briefly described below. The drawings in the following description are only drawings corresponding to some embodiments of the utility model.

FIG. 1 is a first three-dimensional diagram of a hidden pull-out bracket according to an embodiment of the utility model.

FIG. 2 is a second three-dimensional diagram of the hidden pull-out bracket according to an embodiment of the utility model.

FIG. 3 is a vertical view of the hidden pull-out bracket according to an embodiment of the utility model.

FIG. 4 is a structural drawing of a base of the hidden pull-out bracket according to an embodiment of the utility model.

FIG. 5 is a structural drawing of a supporting piece of the hidden pull-out bracket according to an embodiment of the utility model.

FIG. 6 is a schematic diagram showing an internal structure of the supporting piece of the hidden pull-out bracket according to an embodiment of the utility model.

FIG. 7 is a structural drawing of a second connecting piece of the hidden pull-out bracket according to an embodiment of the utility model.

In the drawings, 10 refers to bracket; 11 refers to base; 111 refers to recess; 112 refers to first connecting piece; 1121 refers to first through hole; 1122 refers to rotating shaft; 1123 refers to first limiting block; 113 refers to second connecting piece; 1131 refers to bump; 1132 refers to second through hole; 1133 refers to limiting piece; 1134 refers to second limiting block; 114 refers to anti-skidding piece; 12 refers to supporting piece; 121 refers to storage bucket; 1211 refers to limiting slot; 12111 refers to first clamping position; 12112 refers to second clamping position; 1212 refers to reinforcing rib; 122 refers to fixing piece; and 1221 refers to clamping block.

### DETAILED DESCRIPTION

The following clearly and completely describes the technical solutions in the embodiments of the utility model with reference to the accompanying drawings in the embodiments of the utility model. Apparently, the described embodiments are merely some but not all of the embodiments of the utility model. Based on the embodiments of the utility model, all other embodiments obtained by those skilled in the art without going through any creative work shall fall within the scope of protection of the utility model.

The directional terms mentioned in the utility model, such as “upper”, “lower”, “front”, “back”, “left”, “right”, “inside”, “outside”, “side”, “top” and “bottom”, are only referring to the orientation of the drawings, and the directional terms used are used to explain and understand the utility model, rather than to limit the utility model.

The words “first” and “second” in the terms of the utility model are only used for the purpose of description, but can't be understood as indicating or implying the relative importance, and not as a restriction on the sequence.

In the drawings, units with similar structures are denoted by the same reference numerals.

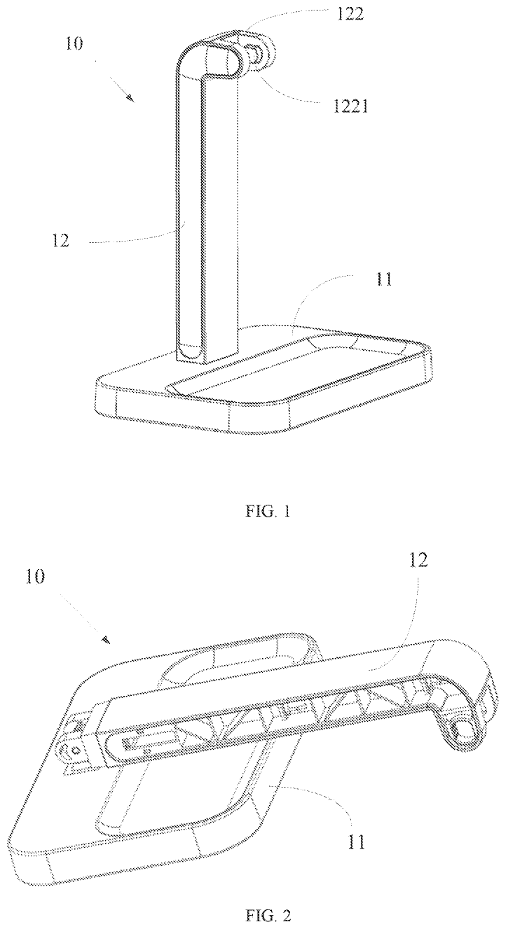

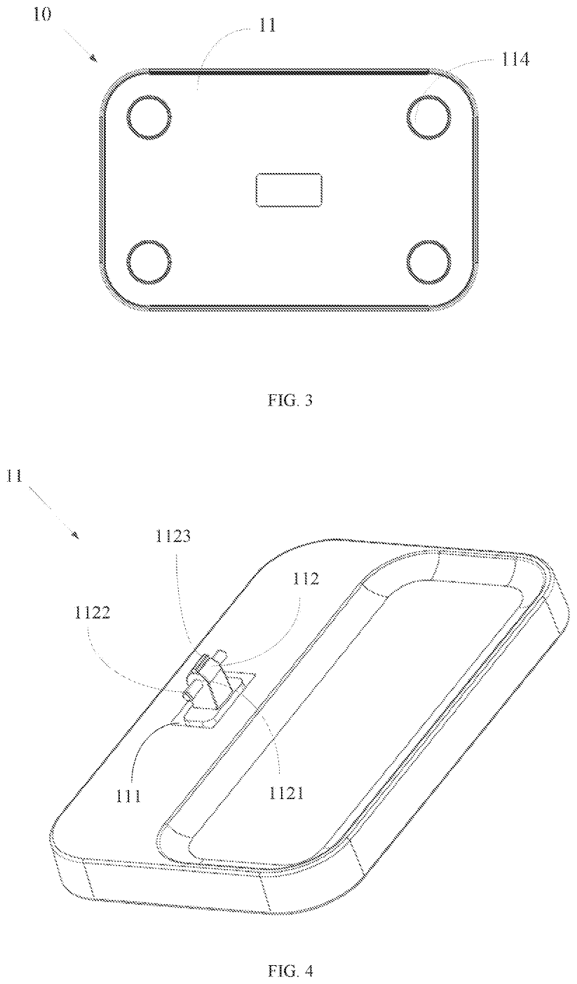

Please referring to FIG. 1 to FIG. 3, the utility model provides a hidden pull-out bracket on which a mirror is installed. The hidden pull-out bracket comprises a base 11 and a supporting piece 12, and the base 11 comprises a recess 111, a first connecting piece 112 and a second connecting piece 113. The recess 111 is arranged on the base 11, a lower end of the first connecting piece 112 is connected to an interior of the recess 111, and an upper end of the first connecting piece 112 protrudes from the recess 111. The first connecting piece 112 is integrally formed with the base 11, so that connection between the first connecting piece 112 and the base 11 is more stable. The second connecting piece 113 is connected to the upper end of the first connecting piece 112, and two sides of the second connecting piece 113 are connected with limiting pieces 1133. The base 11 further comprises a plurality of anti-skidding pieces 114, and the plurality of anti-skidding pieces 114 are connected to a corner position of a lower end of the base 11. The anti-skidding piece 114 can increase a static friction of a contact surface between the base 11 and the anti-skidding piece 114, so that the anti-skidding piece 114 can prevent the base 11 from skidding.

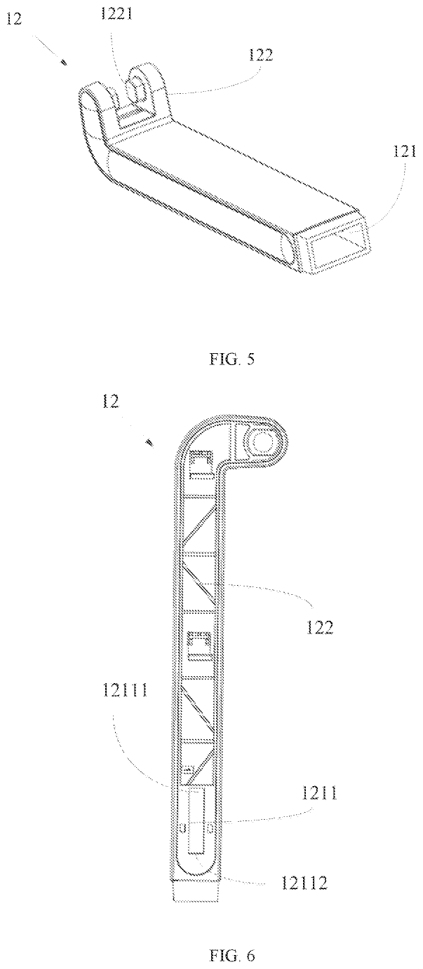

Please referring to FIG. 5 and FIG. 6, one end of the supporting piece 12 is provided with a storage bucket 121, and an inner side of a side wall of the storage bucket 121 is slidably connected to the second connecting piece 113. The storage bucket 121 may be used to accommodate the first connecting piece 112 and the second connecting piece 113. The other end of the supporting piece 12 is connected with a fixing piece 122, and the fixing piece may be used for fixing a mirror. Two fixing pieces 122 are respectively connected with a clamping block 1221, the two clamping blocks 1221 are oppositely arranged, and the clamping blocks 1221 are used for matching with clamping slots or through holes in the mirror to fix the mirror. The supporting piece 12 further comprises a reinforcing rib 1212, and the reinforcing rib 1212 is connected to an interior of the supporting piece 12. The reinforcing rib 1212 may be used for increasing a strength of the supporting piece 12. Because the interior of the supporting piece 12 is connected with the reinforcing rib 1212, the strength of the supporting piece 12 is high, so it is difficult for a user to damage the supporting piece 12.

Please referring to FIG. 4 and FIG. 5, when the supporting piece 12 is located at a first operating position, the storage bucket 121 is sleeved outside the first connecting piece 112 and the second connecting piece 113. The storage bucket 121 is located in an interior of the recess 111, and the storage bucket 121 may be connected to the recess 111. The recess 111 may limit the supporting piece 12 to the first operating position. When the supporting piece 12 is located at a second operating position, the storage bucket 121 is sleeved on an upper end of the second connecting piece 113. The limiting piece 1133 may limit the supporting piece 12 to the second operating position. The supporting piece 12 may be rotationally connected to the first connecting piece 112 through the second connecting piece 113, so that the user can fold the supporting piece 12.

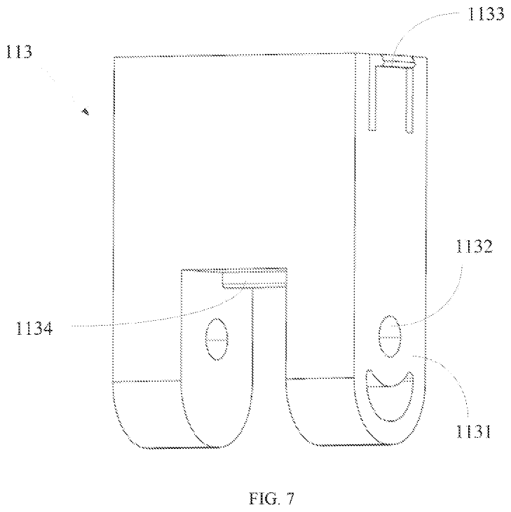

Please referring to FIG. 5 and FIG. 7, the inner side of the side wall of the storage bucket 121 is provided with a limiting slot 1211, the limiting slot 1211 is slidably connected to the limiting piece 1133, and the limiting slot 1211 may be used for limiting the limiting piece 1133. One end of the limiting slot 1211 is provided with a first clamping position 12111, and the other end of the limiting slot 1211 is provided with a second clamping position 12112. when the supporting piece 12 is located at the first operating position, the limiting piece 1133 is connected to the first clamping position 12111. Therefore, the limiting piece 1133 may be matched with the recess 111 to limit the supporting piece 12 to the first operating position. When the supporting piece 12 is located at the second operating position, the limiting piece 1133 is clamped and fixed with the second clamping position 12112. Therefore, the second limiting piece 1133 may limit the supporting piece 12 to the second operating position through the limiting piece 1133.

Please referring to FIG. 4 and FIG. 7, the first connecting piece 112 is provided with a first through hole 1121, the first connecting piece 112 further comprises a rotating shaft 1122, the rotating shaft 1122 is connected in the first through hole 1121, a lower end of the second connecting piece 113 is provided with a second through hole 1132, the rotating shaft 1122 penetrates through the second through hole 1132, and the second connecting piece 113 is rotationally connected to the first connecting piece 112 through the rotating shaft 1122. The second connecting piece 113 comprises a bump 1131, the bump 1131 is connected to the lower end of the second connecting piece 113, and the second through hole 1132 is located in the bump 1131. A lower end of the bump 1131 is semicircular, and the upper end of the first connecting piece 112 is arc-shaped. Since the upper end of the first connecting piece 112 is arc-shaped, the second connecting piece 113 may smoothly rotate along the arc-shaped track. Further, since the lower end of the bump 1131 is semicircular, the second connecting piece 113 may rotate along the quarter circle track, and it is difficult for the second connecting piece 113 to collide with the first connecting piece 112 when rotating. Therefore, the second connecting piece 113 can rotate on the first connecting piece 112 more smoothly.

Please referring to FIG. 2, when the supporting piece 12 rotates through the second connecting piece 113 and the first connecting piece 112, the supporting piece 12 is located at a third operating position, and the supporting piece 12 is parallel to the base 11. Since the supporting piece 12 is parallel to the base 11, the bracket 10 occupies less space. Therefore, it is easier for the user to store the bracket 10, and it is more convenient for the user to carry the bracket 10. The upper end of the first connecting piece 112 is connected with a first limiting block 1123, the lower end of the second connecting piece 113 is connected with a second limiting block 1134, and the second limiting block 1134 is located between the two bumps 1131. When the second connecting piece 113 rotates on the first connecting piece 112, the second limiting block 1134 may be matched with the first limiting block 1123 to limit the second connecting piece 112. When the supporting piece 12 is located at the second operating position, the supporting piece 12 may form an included angle with the base 11. The supporting piece 12 is connected to the first connecting piece 112, and the supporting piece 12 can rotate together with the first connecting piece 112. Because the second limiting block 1134 and the first limiting block 1123 limit the first connecting piece 112, the supporting piece 12 can only rotate within the included angle, that is, a rotating angle of the supporting piece 12 is smaller than the included angle. Therefore, the user can avoid the excessive angle of the supporting piece 12, and it is more convenient for the user to use the bracket 10.

The working principle of the utility model is as follows: when the user uses the bracket 10, the user may first rotate the rotating bracket 10 first. In this case, as the limiting pieces 1133 on both sides of the second connecting piece 113 are connected to the second clamping position 12112 on the limiting slot 1211, the bracket 10 can rotate through the second connecting piece 113 and the first connecting piece 112. Then, the supporting piece 12 rotates to the second operating position, and the second limiting block 1134 is matched with the first limiting block 1123 to limit the supporting piece 12. Then, the user presses the supporting piece 12 from the second operating position to the first operating position. In this case, the limiting piece 1133 is connected to the first clamping position 12111 on the limiting slot 1211, and one end of the storage bucket 121 is located in the recess 111 of the base 11. After that, the user may place the bracket 10 on a desktop, and the user may install the mirror on the bracket 10 through the clamping block 1221 on the fixing piece 122, so that the user can use the mirror. In order to prevent the base 11 from skidding, a plurality of anti-skidding pieces 114 are connected to the lower end of the base 11.

When the user needs to store the bracket 10, the user pulls the mirror from the first operating position to the second operating position. Then, the supporting piece 12 may rotate through the second connecting piece 113 and the first connecting piece 112, and the user can fold the supporting piece 12. In order to increase a strength of the supporting piece 12, a reinforcing rib 1212 is connected to an interior of the supporting piece 12. When the user rotates the supporting piece 12 from the second operating position to the third operating position, the supporting piece 12 is parallel to the base 11. For the supporting piece 12 to rotate smoothly, the upper end of the first connecting piece 112 is arc-shaped, and the lower end of the bump 1131 is semicircular. Then, the user can store the bracket 10.

The utility model provides a hidden pull-out bracket, on which a mirror is installed. The bracket comprises a supporting piece and a base, and one end of the supporting piece is provided with a storage bucket. When the supporting piece is located at a first operating position, the storage bucket is sleeved outside a first connecting piece and a second connecting piece. Moreover, one end of the storage bucket is located in a recess of the base. Therefore, both the first connecting piece and the second connecting piece are hidden in the storage bucket, such that a height of the hidden pull-out bracket is reduced. Therefore, when a user uses the hidden pull-out bracket, the hidden pull-out bracket can save a part of space needed thereof. Moreover, after the user pulls out the supporting piece from the first operating position to the second operating position, the supporting piece can rotate through the second connecting piece and the first connecting piece, so that the user can fold the supporting piece. After the user folds the supporting piece, the user can conveniently carry the bracket. The technical problem that it is inconvenient for the user to carry the existing bracket is effectively solved.

To sum up, although the utility model has been disclosed in the preferred embodiments, the above preferred embodiments are not intended to limit the utility model, and those having ordinary skills in the art can make various changes and embellishments without departing from the spirit and scope of the utility model. Therefore, the scope of protection of the utility model is subject to the scope defined in the claims.

1. A hidden pull-out bracket, comprising:
a base, comprising:
a recess arranged on the base;
a first connecting piece, a lower end of the first connecting piece being connected to an interior of the recess, and an upper end of the first connecting piece protruding from the recess;
a second connecting piece connected to the upper end of the first connecting piece, two sides of the second connecting piece being connected with limiting pieces; and
a supporting piece, one end of the supporting piece being provided with a storage bucket, an inner side of a side wall of the storage bucket being slidably connected to the second connecting piece, the storage bucket being used for storing the first connecting piece and the second connecting piece, the other end of the supporting piece being connected with a fixing piece, and the fixing piece being used for fixing a mirror;
wherein, when the supporting piece is located at a first operating position, the storage bucket is sleeved outside the first connecting piece and the second connecting piece, one end of the storage bucket is located in the interior of the recess, and the recess limits the supporting piece to the first operating position; and when the supporting piece is located at a second operating position, the storage bucket is sleeved on an upper end of the second connecting piece, the limiting piece limits the supporting piece to the second operating position, and the supporting piece is rotationally connected to the first connecting piece through the second connecting piece, and used for folding the supporting piece.

2. The hidden pull-out bracket according to claim 1, wherein the inner side of the side wall of the storage bucket is provided with a limiting slot, the limiting slot is slidably connected to the limiting piece, the limiting slot is used for limiting the limiting piece, one end of the limiting slot is provided with a first clamping position, the other end of the limiting slot is provided with a second clamping position, when the supporting piece is located at the first operating position, the limiting piece is connected to the first clamping position, and when the supporting piece is located at the second operating position, the limiting piece is clamped and fixed with the second clamping position.

3. The hidden pull-out bracket according to claim 1, wherein the first connecting piece is provided with a first through hole, the first connecting piece further comprises a rotating shaft, the rotating shaft is connected in the first through hole, a lower end of the second connecting piece is provided with a second through hole, the rotating shaft penetrates through the second through hole, and the second connecting piece is rotationally connected to the first connecting piece through the rotating shaft.

4. The hidden pull-out bracket according to claim 1, wherein when the supporting piece rotates through the second connecting piece and the first connecting piece, the supporting piece is located at a third operating position, and the supporting piece is parallel to the base.

5. The hidden pull-out bracket according to claim 1, wherein the first connecting piece is integrally formed with the base.

6. The hidden pull-out bracket according to claim 3, wherein the second connecting piece comprises a bump, the bump is connected to the lower end of the second connecting piece, the second through hole is located in the bump, a lower end of the bump is semicircular, and the upper end of the first connecting piece is arc-shaped.

7. The hidden pull-out bracket according to claim 6, wherein the upper end of the first connecting piece is connected with a first limiting block, the lower end of the second connecting piece is connected with a second limiting block, the second limiting block is located between the two bumps, and when the second connecting piece rotates on the first connecting piece, the second limiting block is used for matching with the first limiting block to limit the second connecting piece.

8. The hidden pull-out bracket according to claim 1, wherein the supporting piece comprises a reinforcing rib, and the reinforcing rib is connected to an interior of the supporting piece.

9. The hidden pull-out bracket according to claim 1, wherein two fixing pieces are respectively connected with a clamping block, the two clamping blocks are oppositely arranged, and the clamping blocks are used for matching with clamping slots or through holes in the mirror to fix the mirror.

10. The hidden pull-out bracket according to claim 1, wherein the base further comprises a plurality of anti-skidding pieces, the anti-skidding pieces are connected to a lower end of the base, and the anti-skidding pieces are used for preventing the base from skidding.
